(19) United States
(12) Patent Application Publication
(10) Pub. No.: US 2004/0064330 A1
(43) Pub. Date: Apr. 1, 2004

(54) Method and apparatus for screening applicants for employer incentives/tax credits

(76) Inventors: Matthew Bruce Keelan, Richardson, TX (US); Steven Farrel Clower, Clyde, TX (US); Gregg Gerard Guttuso, Abilene, TX (US); Marty Lee Arbuckle, McKinney, TX (US); Bonita Lynn Richardson, Ponder, TX (US); Michelle Helaine Segal, Dallas, TX (US); Christy Dawn McDonald, Wylie, TX (US); Kathleen Michele Howe, Dallas, TX (US); Michael Allen Eden, Dallas, TX (US)

Correspondence Address: Stephen J. Walder, Jr.,, Carstens, Yee & Cahoon, LLP, P. O. Box 802334, Dallas, TX, 75380, US

(21) Appl. No.: 10/339,901

(22) Filed: Jan. 10, 2003

Related U.S. Application Data
(60) Provisional application No. 60/414,658, filed on Sep. 30, 2002.

(51) Int. Cl. G06F 17/60

(52) U.S. Cl. 705/1

(57) ABSTRACT

Methods and apparatus for screening applicants to determine whether the applicant is a candidate under one or more incentive/tax credit programs established by either a government agency, the employer, or the like, are provided. An applicant makes use of one or more interfaces provided via a client device to enter appropriate information and transmit this information back to a remote server. This information is processed to determine whether the applicant qualifies as a candidate under one or more incentive/tax credit programs. The one or more incentive/tax credit programs may be identified based on a profile established for the particular employer. The processing of the applicant information may involve applying one or more sets of business rules, established for the one or more incentive/tax credit programs, to the applicant's answers to various questions in a questionnaire. In one embodiment, the processing may further include validation of the applicant information through automatic interfacing with government, employer, and third party computing systems. The method and apparatus further provide for automated filing of forms to obtain the employer incentive/tax credit.

### RELATED PROVISIONAL APPLICATION

The present invention is related to and claims the benefit of priority to provisional U.S. Patent Application Serial No. 60/414,658 entitled “Method and Apparatus for Screening Applicants for Employer Incentives/Tax Credits,” filed on Sep. 30, 2002, which is hereby incorporated by reference.

### BACKGROUND OF THE INVENTION

1. Technical Field

The present invention is directed to a method and apparatus for screening applicants for employer incentives/tax credits established by government agencies, the employer, or the like. More specifically, the present invention provides a mechanism for taking job applicant information, verifying the information, determining if the applicant is a candidate under an incentive/tax credit program, and filing appropriate documents for obtaining the employer incentive/tax credit.

2. Description of Related Art

Federal and state governments provide programs to aid people in obtaining employment. Some of these programs are in the form of incentives and tax credits to employers for hiring persons having particular qualifications. For example, under the Work Opportunity Tax Credit and Welfare to Work programs, employers are provided with a tax credit for each employee they hire that meets certain qualifications. In particular, the qualifications involve whether the individual has been convicted of a felony and released within the last year, is part of a pre-release program, is currently enrolled in a state or veteran sponsored vocational rehabilitation program, or has received some sort of family aid under a government program including food stamps, supplemental security income, or the like.

Typically, an employer must have an applicant for employment fill out a form, such as IRS Form 8850 “Pre-Screening Notice and Certification Request for the Work Opportunity Tax Credit and Welfare-to-Work Credit,” (hereafter referred to as WOTC/WtW) and have a human resources person review the form, verify its contents, and determine if the applicant qualifies for the tax credit. This can be a great burden and require many man-hours to perform. For large companies, who may have many geographical locations, this burden is greatly increased, especially if turnover in the workforce is large.

Companies have outsourced this procedure to third party companies who specialize in identifying applicants qualifying under the WOTC/WtW programs. While outsourcing this procedure lowers the cost to the companies contracting with these third parties, the process is still largely a manual one in which applicants manually fill out forms, the forms are transported to the third party, a human reviews the forms and determines whether the applicant is a candidate under the WOTC/WtW programs, and then files the forms by mail with the appropriate government office. Thus, the burden of determining whether an applicant qualifies under the WOTC/WtW programs are still on the shoulders of a human being even though that human being is not a direct employee of the contracting company.

In view of the above, it would be beneficial to have a method and apparatus for automatically screening job applicants to determine if they qualify for an employer incentive and/or tax credit program established by a government agency, the employer, or the like. Furthermore, it would be beneficial to have a method and apparatus for automatically interfacing with employer, state and federal government, and third party computing systems to perform validation of information submitted by the applicant, filing of appropriate forms with the regulating entities, and performing employment verification for determining incentives/tax credits earned by employer and compensation to a third party vendor of the applicant screening service.

### SUMMARY OF THE INVENTION

The present invention provides a method and apparatus for screening applicants to determine whether the applicant is a candidate under one or more incentive/tax credit programs established by either a government agency, the employer, or the like. In a preferred embodiment of the present invention, an applicant makes use of one or more interfaces provided via a client device that either stores these interfaces locally or obtains these interfaces from a remote server. The applicant enters appropriate information via the interfaces and transmits this information back to the remote server. In addition to the applicant information, an identifier of one or more employers with which the applicant is applying for employment is also sent to the remote server.

Once the server receives the applicant information and employer identification, it is processed to determine whether the applicant qualifies as a candidate under one or more incentive/tax credit programs, such as the Work Opportunity Tax Credit and Welfare to Work (WOTC/WtW) programs. The one or more incentive/tax credit programs may be identified based on a profile established for the particular employer.

The processing of the applicant information may involve applying one or more sets of business rules, established for the one or more incentive/tax credit programs, to the applicant's answers to various questions in a questionnaire. In one embodiment, the processing may further include validation of the applicant information through automatic interfacing with government, employer, and third party computing systems.

If the applicant is identified as a candidate of one or more incentive/tax credit programs, the appropriate forms for applying for the incentive/tax credit may be output for signing by the applicant and ultimate filing with the appropriate regulating office. In one embodiment of the present invention, the forms may be output as electronic forms on a display of a client device and an interface provided through which the applicant may submit an electronic signature. The electronic forms may then be electronically filed with the regulating office via a communication connection between the client device and/or server supporting the client device and the regulating office computing system.

Having filed with the appropriate regulating office, the present invention further provides a mechanism for monitoring the employment of the applicant to determine incentives/tax credits earned by employer and compensation for the screening service provider. Such monitoring may include interfacing with the employer payroll computing system to verify continued employment of the applicant, payment information, and the like. Based on this verification, a report of tax credits earned by the employer and a bill for services may be generated by the screening service provider and either output for mailing or transmitted to the employer electronically.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which the present invention may be implemented;

FIG. 2 is an exemplary block diagram of a server apparatus according to the present invention;

FIG. 3 is an exemplary block diagram of a client apparatus according to the present invention;

FIG. 4 is an exemplary block diagram illustrating the primary parties involved in an applicant screening process according to one embodiment of the present invention;

FIG. 5 is an exemplary diagram illustrating a process of performing applicant screening according to one embodiment of the present invention;

FIG. 6 is an exemplary block diagram of an applicant screening and processing system according to one embodiment of the present invention;

FIG. 7A is a flowchart outlining an exemplary operation of the present invention with regard to a logon process;

FIG. 7B is a flowchart outlining an exemplary operation of the present invention with regard to a process for screening an applicant;

FIG. 7C is a flowchart outlining an exemplary operation of the present invention with regard to a process for evaluating applicant information obtained through screening;

FIG. 7D is a flowchart outlining an exemplary operation of the present invention with regard to a process for generating a report;

FIG. 8A is an exemplary diagram of an interface for logging-on to an applicant screening and processing system according to one embodiment of the present invention;

FIG. 8B is an exemplary diagram of an interface for providing personal information about an applicant according to one embodiment of the present invention;

FIG. 8C is an exemplary diagram of an interface for performing applicant screening according to one embodiment of the present invention;

FIG. 8D is an exemplary diagram of an interface for providing criminal history information according to one embodiment of the present invention;

FIG. 8E is an exemplary diagram of an interface for providing employment detail information according to one embodiment of the present invention;

FIG. 8F is an exemplary diagram of an interface for informing an employer that the applicant may be a candidate under an incentive/tax credit program according to one embodiment of the present invention;

FIG. 8G is an exemplary diagram of an interface for generating one or more documents for applying for the incentive/tax credit according to one embodiment of the present invention;

FIG. 8H is an exemplary diagram of an interface for informing an employer of a control number for tracking an applicant that has been screened for an incentive/tax credit program according to one embodiment of the present invention;

FIG. 8I is an exemplary diagram of an interface for performing a reprint of surveys according to one embodiment of the present invention;

FIG. 8J is an exemplary diagram of an interface for obtaining an employer report according to one embodiment of the present invention;

FIG. 8K is an exemplary diagram of an employer report according to one embodiment of the present invention;

FIG. 9 is an exemplary block diagram of a distributed data processing system according to another exemplary embodiment of the present invention;

FIG. 10 is a flowchart outlining an exemplary operation of one embodiment of the present invention with regard to automatically performing verification of applicant information and interfacing with employer, government and third party agencies;

FIG. 11 is a flowchart outlining an exemplary operation of one embodiment of the present invention for interfacing with an employer payroll system to verify employment information, generate a report of tax credits earned by employer, and generate billing; and

FIG. 12 is an exemplary block diagram of an applicant screening and processing system according to another exemplary embodiment.

### DETAILED DESCRIPTION OF THE PREFERRED EMBODIMENTS

The present invention provides a mechanism for screening and processing applicants to determine if they are candidates under one or more incentive/tax credit programs established by government agencies, the employer, or the like. The present invention may be implemented in a stand-alone computing system or in a distributed computing environment.

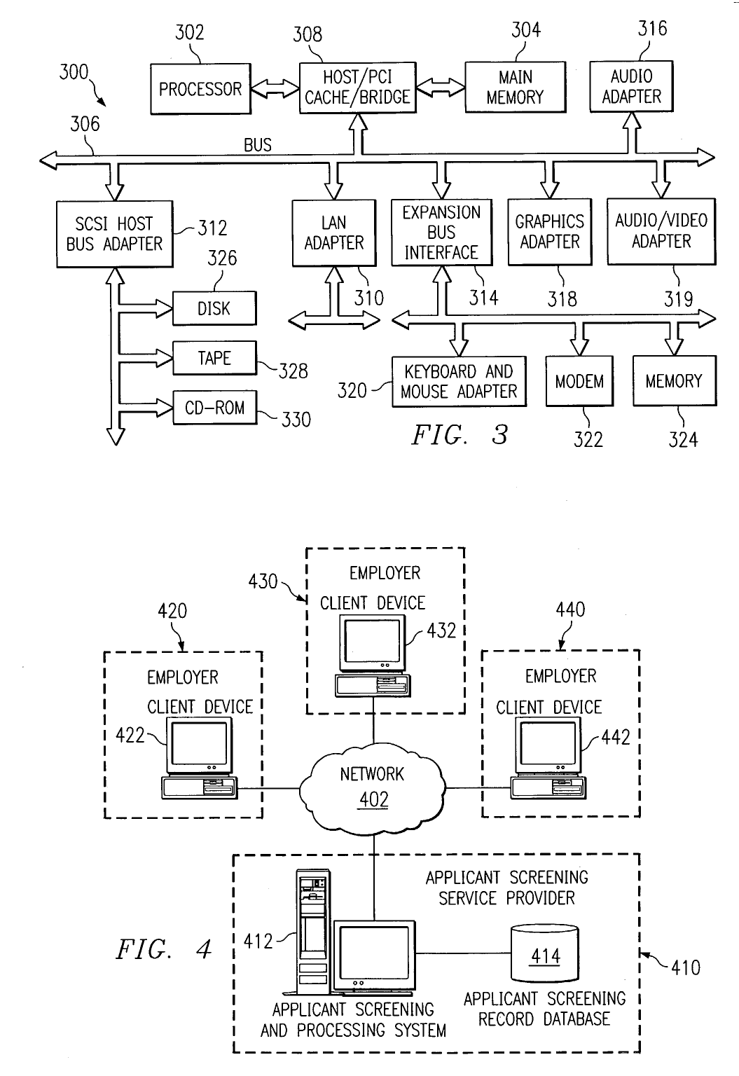

In a preferred embodiment, the present invention is implemented in a distributed computing environment in which applicants use client devices to input applicant information and transmit the applicant information to an applicant screening/processing system via one or more networks. As such, the following diagrams in FIGS. 1-3 are intended to provide a general description of the devices in the distributed data processing system in order to provide a context in which the present invention may be implemented. It should be appreciated, however, that in an embodiment of the present invention where the present invention is implemented in a stand-alone computing device, the functions of the present invention may be implemented in a device similar to that described hereafter in FIG. 3.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

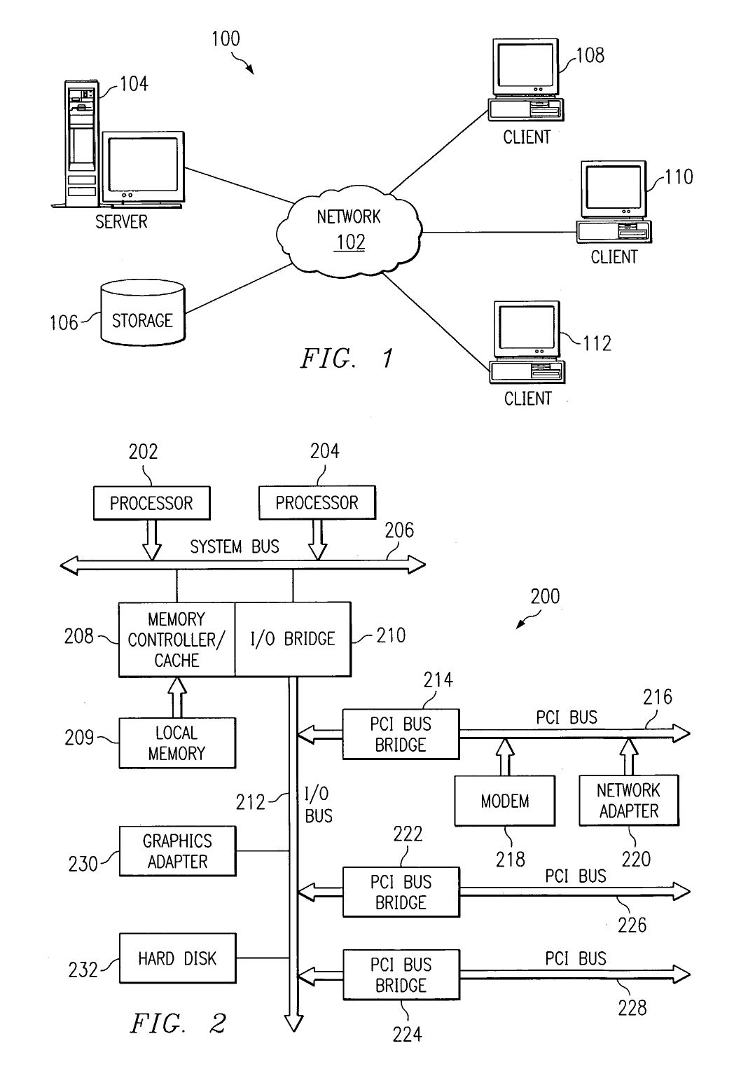

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object-oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance. For example, in one embodiment of the present invention, the data processing system 300 is a kiosk located in a shopping mall, unemployment office, or other location where individuals seeking employment are likely to be.

As mentioned above, the present invention provides a method and apparatus for screening and processing applicant information to determine if the applicant qualifies under one or more incentive/tax credit programs. These programs may be established by the employer, a government agency, or the like. For example, the present invention may be used to determine whether applicants qualify under the Work Opportunity Tax Credit and Welfare to Work (WOTC/WtW) programs established by the Federal government. Similarly, many state governments may establish their own incentive/tax credit programs having various criteria for determining whether the hiring of an applicant qualifies the employer for an incentive or tax credit. Moreover, the company, i.e. employer, may determine that the hiring of certain individuals for different departments or branches of the company is beneficial and may offer incentives, such as budget increases, to those branches and departments to hire those individuals.

The present invention provides a method and apparatus for automatically identifying applicants that meet the criteria for one or more of these incentive/tax credit programs. The following description of the preferred embodiments of the present invention will assume that the screening and processing is performed with regard to the WOTC/WtW programs criteria, however, it should be appreciated that the present invention is not limited to such. Rather, as stated previously, the present invention may be used to perform screening under various criteria established under one or more incentive/tax credit programs.

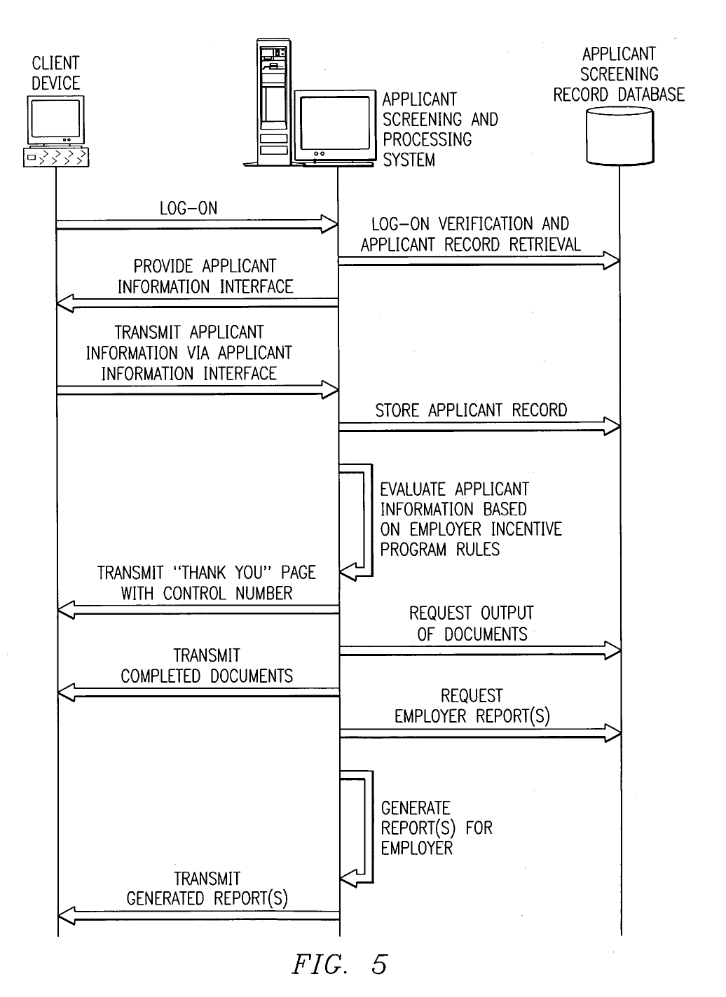

FIG. 4 is an exemplary block diagram illustrating the primary parties involved in an applicant screening process according to one embodiment of the present invention. As shown in FIG. 4, the primary parties involved in the screening process are the applicant screening service provider 410 and one or more employers 420, 430 and 440. The applicant screening service provider 410 includes an applicant screening and processing system 412 coupled to an applicant screening record database 414.

Each employer 420, 430 and 440 includes at least one client device 422, 432 and 442 for communicating with the applicant screening and processing system 412 via at least one network 402. The client devices 422, 432 and 442 may be any computing device capable of receiving user input and transmitting/receiving data to/from the applicant screening and processing system 412. The user of the client device 422, 432 or 442, may enter information via a user interface such as a keyboard, mouse, pointing device, voice recognition input device and associated software, touch screen, and the like. The information entered may be stored temporarily in a temporary storage device for transmission to the applicant screening and processing system 412.

While FIG. 4 illustrates the client devices 422, 432 and 442 being in communication with the applicant screening and processing system 412 via at least one network 402, the present invention is not limited to such an embodiment. Rather, one or more of the client devices 422, 432 and 442 may be directly coupled to the applicant screening and processing system 412 without departing from the spirit and scope of the present invention. Furthermore, the applicant screening and processing system 412 may have an integrated client device such that an applicant may enter information directly into the applicant screening and processing system 412 without the need for communication over a communication link from a client device to the applicant screening and processing system.

The client devices 422, 432 and 442 either obtain appropriate applicant interfaces from the applicant screening and processing system 412 or have these interfaces already stored locally for use by the applicant in providing personal information about himself/herself. In the depicted embodiment, the applicant information entered via these interfaces is transmitted to the applicant screening and processing system 412 via the network 402.

The network 402 may be a single network or may be any combination of networks including local area networks (LANs), wide area networks (WANs), the Internet, wireless networks, infrared networks, satellite based networks, and the like. The network 402 may make use of one or more communication protocols. Since the client devices 422, 432 and 442 are communicating sensitive personal information about applicants to the applicant screening and processing system 412 and vice versa, it is preferable to have security measures associated with the communication protocols such as data encoding/decoding, digital certificates, electronic signatures, and the like. In a preferred embodiment, the network 402 is the Internet and the client devices 422, 432 and 442 communicate with the applicant screening and processing system using the HyperText Transport Protocol (HTTP) and, in particular, the secure form of HTTP called HyperText Transport Protocol Secure (HTTPS). It should be appreciated that other secure protocols, such as Secure HyperText Transport Protocol (SHTTP), Secure Sockets Layer (SSL), Private Communications Technology (PCT), Internet Protocol Security (IPSec) and the like, may be used without departing from the spirit and scope of the present invention.

The applicant screening and processing system 412 receives the applicant information from one or more of the client devices 422, 432 and 442, and performs a number of checks of the applicant information to identify internal consistency and completeness of the applicant information. For example, the applicant screening and processing system 412 checks the applicant information to determine if the applicant correctly entered his/her social security number, that date information is entered in the proper format, that all required fields have entries, and the like.

Following the internal consistency and completeness checks, the applicant screening and processing system 412 generates a control number, or record identifier, and stores the applicant information in the applicant screening record database 414. The applicant screening and processing system 412 then, or at approximately the same time as the storing of the record, applies one or more sets of business rules to the applicant information to evaluate whether the applicant qualifies under one or more incentive/tax credit programs.

If the applicant does not qualify under one or more of the incentive/tax credit programs, the employer is simply informed of the control number for later use in referencing the applicant's record in the applicant screening record database 414. If the applicant does qualify under one or more of the incentive/tax credit programs, an interface is provided to the client device (or alternatively retrieved from a local storage) for entry of additional employment information. This employment information may include, for example, start date, salary, job title, and the like. The employment information and the control number is then transmitted to the applicant screening and processing system 412.

The applicant screening and processing system 412 performs internal checks of the employment information and stores this employment information in association with the applicant screening record in the applicant screening record database 414. For example, the internal checks may include verifying that the applicant and employment information are being processed before the applicant's estimated start of employment date (a requirement under the WOTC/WtW programs). Other types of internal checks, including proper formatting of entries, that all required fields have entries, etc., may be performed based on the particular incentive/tax credit program and implementation of the present invention.

The applicant screening and processing system 412 then provides an interface for informing the applicant of the control number for his/her applicant screening record and for generating the required forms to apply for the incentive/tax credit under the appropriate program. These forms may be output via a printer or other appropriate output device local to the client device 422, 432 or 442. The employer need only have the applicant sign the forms and then submit them to the appropriate regulating agency or send them to the applicant screening service provider 410 for handling.

Upon outputting the forms at the local device associated with the client device 422, 432 or 442, an indicator of the date and time at which the forms were output may be stored in association with the applicant screening record. This date and time may serve as an indication that the employer has applied for the incentive/tax credit and may be used to determine when the applicant screening service provider is to be paid compensation for their services. Moreover, this information may also be used as part of one or more reports generated for the employer by the applicant screening service provider 410.

Upon request, or at periodic intervals, the applicant screening and processing system 412 may generate one or more reports for the employers 420, 430 and 440 based on the applicant screening records stored in the applicant screening record database 414. These reports may identify, for example, the number of applicants screened in the past x months, the number identified as qualifying under an incentive/tax credit program, which programs the applicants qualified under, the percentage of applicants that qualified under the various programs, the number of qualified applicants for which forms were timely filed, the number of qualified applicants for which forms were filed too late, the number of qualified applicants for which forms were not filed, and the like. In short, any statistical information that an employer may be interested in knowing based on applicant screenings and processing may be generated using the information stored in the applicant screening record database 414.

These reports may be automatically generated and output at the local device associated with the client device 422, 432 or 442, or output from the applicant screening and processing system 412 for mailing to the employer, or transmitted electronically to the employer computing systems via the network 402. The particular format and information contained in the reports may be identified based on employer profiles stored in an employer profile database (not shown) associated with the applicant screening and processing system 412. Thus, the reports generated for one employer may be different from those of another employer. In this way, custom reports may be generated for each employer based on the needs and desires of the employer.

The above description provides an overview of some of the features of the present invention. The details of the steps involved in screening and processing applicant information according to one preferred embodiment will now be provided in conjunction with FIG. 5.

FIG. 5 is an exemplary diagram illustrating a process of performing applicant screening according to one embodiment of the present invention. The process shown in FIG. 5 assumes that the user selects the option of entering applicant information from an opening page and further, that the applicant information indicates that the applicant is a candidate under an incentive/tax credit program. The other, alternative, outcomes of processing by the present invention will be discussed in the following text.

As shown in FIG. 5, the process begins with a user logging-on to the applicant screening and processing system. The log-on process is intended to restrict access to the applicant screening and processing system to only those users that have registered with, and have been approved for access by, the applicant screening and processing system. If an unauthorized user attempts to log-on to the applicant screening and processing system, an automatic log-out process is performed after a predetermined number of tries to log-on or a predetermined period of time of inactivity by the client device.

In a preferred embodiment, the log-on to the applicant screening and processing system is performed via an opening web page that requires the user to enter the user's identification, password, and optionally the social security number of the applicant. The user is also provided with an interface to select to either enter applicant information, generate a report, or re-output a form.

The user identification may be used to identify the particular employer and the employer's location with which the applicant is applying for a position. Alternatively, if the applicant is applying for a position with a number of different employers, the opening screen may include a field for designating with which employers the applicant wishes to apply. Such designation may include selecting from a list of employers, entering employer identifiers, and the like.

The interface may provide options regarding the particular language in which questions and field titles will be output in the applicant information interfaces. For example, if the applicant information interface includes a questionnaire, the user may select that the questions in the questionnaire be presented in English, Spanish, German, French, etc. In addition, fields such as “Name,” “Address,” “Telephone Number,” etc. may be output in the selected language.

The opening page further includes a “submit” virtual button for submitting the user identifier, password, etc. to the applicant screening and processing system. When the user presses the “submit” virtual button, the information entered via the opening page is transmitted to the applicant screening and processing system where the user identifier and password are compared against authentication records in an authorized user database (not shown) associated with the applicant screening and processing system.

There are three possible outcomes for the authentication of the user identifier and password: the user identifier is not found in the database, the user identifier is found but the password entered does not match the one in the database, or the user identifier and password match the database record. If the user identifier is not found or the password is incorrect, the user is again presented with the opening page and informed of the particular error encountered. In this way, the user is provided with another opportunity to attempt a log-on to the applicant screening and processing system using corrected information.

If the user identifier and password match the database record, the applicant screening and processing system determines which option the user selected, i.e. generate report, re-output form, or enter applicant information. In any of the above options, the applicant screening record database is accessed to retrieve one or more applicant records. If the option selected is to generate a report, an appropriate interface (which may be part of the opening page) is provided for entry of date ranges for the report to be generated and appropriate applicant records are retrieved from the applicant screening record database. If the option selected is to re-output forms, the applicant screening record corresponding to the entered social security number is retrieved from the applicant screening record database and used to generate the forms for re-outputting of the forms.

If the option selected is to enter applicant information, an applicant information interface is provided to the client device. If the applicant has previously submitted applicant information, this applicant information may be retrieved from the applicant screening record stored in the applicant screening record database and automatically entered into the appropriate fields of the applicant information interface. In this way, re-entry of applicant information is minimized.

The applicant interface, in a preferred embodiment, takes the form of questionnaire in which the applicant enters various personal information including first name, last name, address, social security number, driver's license number, telephone number, date of birth, electronic mail address, and the like. This information may be stored in the applicant screening record database regardless of whether the applicant completes or does not complete the survey described below.

The applicant interface further includes a survey portion in which the applicant selects “Yes,” “No,” or “Not Sure” to a number of questions designed to determine whether the applicant is a candidate under one or more incentive/tax credit programs. The particular questions included in the survey portion may be tailored to the particular employer with which the applicant is applying for a position. For example, if a first employer has a first set of incentive/tax credit programs that it may qualify under, a first set of questions may be presented to the applicant. If a second employer has a second set of incentive/tax credit programs, different from the first set of incentive/tax credit programs, that it may qualify under, a second set of questions may be presented to the applicant. Furthermore, the questions presented may be in the particular language selected via the opening page.

As an example of a survey that may be presented to an applicant, consider a survey for use with determining whether an applicant is a candidate under the WOTC/WtW programs. The survey may consist of the following set of questions and corresponding answer choices of “Yes,” “No” or “Not Sure”:

1. I am a member of a family that received assistance from Aid to Families with Dependent Children (AFDC or TANF) for:

At least 9 of the last 18 months.

The last 18 consecutive months.

Any 18-month period beginning after Aug. 5, 1997.

2. I am a member of a family that can no longer receive assistance from Aid to Families with Dependent Children (AFDC or TANF) after Aug. 5, 1997 due to government limitations.

3. I am a member of a family that received Food Stamps for:

The last 6 consecutive months.

At least 3 of the last 15 months.

4. I am a member of a family that received Food Stamps for at least 3 of the last 5 months, but no longer eligible to receive them.

5. I am 18-24 years of age.

6. I am currently enrolled in or have completed a State or Veteran sponsored Vocational Rehabilitation Program.

7. I am a military veteran.

8. I have received Supplemental Security Income (SSI) for at least 1 month of the last 3 months.

9. I was convicted or released from prison for a felony within the last year or I am in a pre-release program.

Each of these questions may further include fields for entry of further information regarding the answers to those questions. For example, these fields may allow the applicant to enter the branch of military service in which they served, the dates of service, the date of the applicant's conviction, date of release of the applicant from prison, etc.

When the applicant completes the questionnaire via the applicant information interfaces, the client device transmits the applicant information to the applicant screening and processing system which generates a control number for the completed questionnaire and stores an applicant screening record in the applicant screening record database associated with both the applicant and the employer(s). The control number may be used at a later time to specifically identify a particular questionnaire from the applicant screening record database. Thus, the same applicant may submit a plurality of applications for the same or different employers and each application will be uniquely identified by a unique control number.

After having generated the control number and stored the applicant information, the applicant screening and processing system evaluates the applicant information based on business rules associated with the particular incentive/tax credit programs identified in the employer profile(s). For example, if the employer functions under the WOTC/WtW programs, and the applicant enters responses to the survey set forth above, the business rules applied to the applicant information to determine if the applicant qualifies under WOTC/WtW may include determining if the applicant responded “Yes” or “Not Sure” to any of the following:

Question 1—bullet 1, 2 or 3.

Question 2.

Question 3—bullet 1 and question 5.

Questions 4 and 5.

Question 5 and have a matching zip code, meaning the employer's zip code and/or the applicant's zip code match the zip code of a distressed geographical area as defined by the various incentive/tax credit programs.

Question 6.

Questions 7 and 3.

Questions 7 and 4.

Question 8.

Question 9.

All other possible scenarios may be considered as the applicant not qualifying under the WOTC/WtW programs. Similar rules may be generated for different incentive/tax credit programs depending on the particular survey questions submitted in the applicant information interface and the particular requirements under the incentive/tax credit program. The present invention may implement any business rule set and any set of questions deemed appropriate under the circumstances. Furthermore, the present invention may apply different sets of business rules to the applicant information to determine if the applicant qualifies under any number of different incentive/tax credit programs.

If the application of the business rules to the applicant information indicates that the applicant is not a candidate under one or more of the incentive/tax credit programs, the applicant screening and processing system returns a “thank you” page to the client device informing the applicant of his/her control number for later use and thanking the applicant for taking the time to complete the questionnaire. The applicant is not given the opportunity to generate the forms for filing for the incentive/tax credit programs because they are not eligible for these programs based on the information submitted.

If the application of the business rules to the applicant information indicates that the applicant is a candidate under one or more of the incentive/tax credit programs, the applicant screening and processing system transmits a “thank you” page with the control number and options to generate forms for signature by the applicant in order to file for the employer incentive/tax credit. These completed documents are then transmitted to the client device where the employer may print out the forms and sign them, have them signed by the applicant, and mail them to the appropriate regulating agency or the applicant screening service provider.

In addition, as mentioned previously, the user may select to have one or more employer reports generated. If the user selects this option, the selected reports are generated based on the employer profile(s) and the applicant screening records in the applicant screening records database. These reports are then provided to the client device for use by the employer.

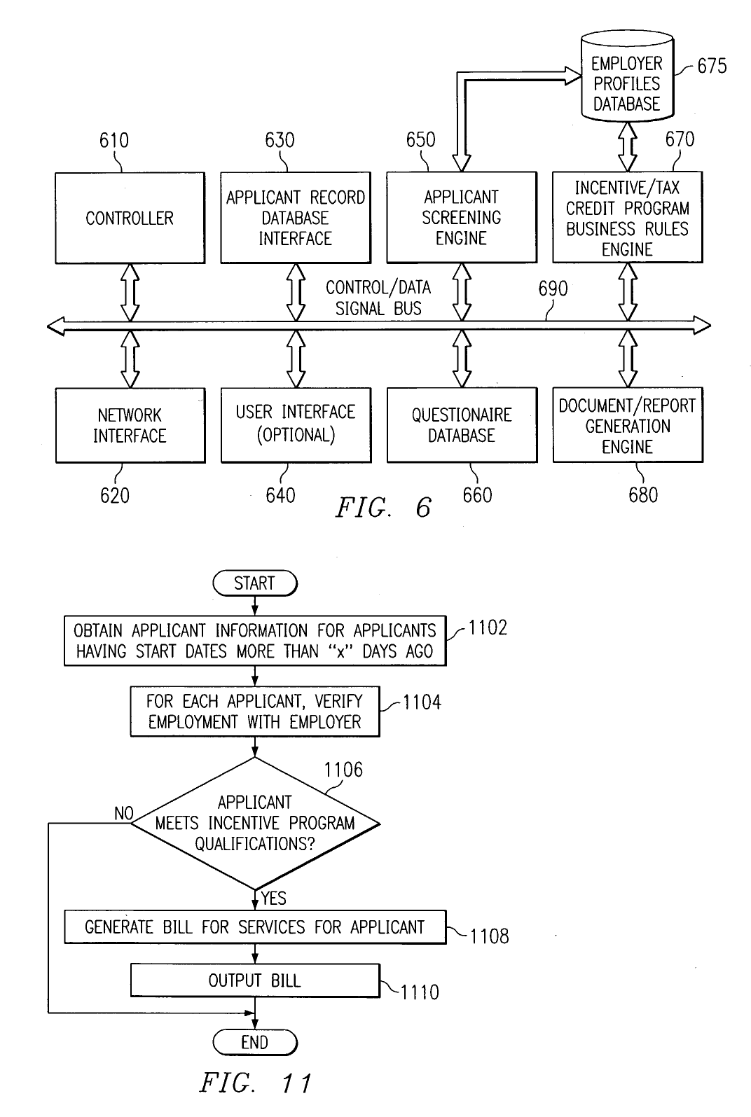

FIG. 6 is an exemplary block diagram of an applicant screening and processing system according to one embodiment of the present invention. The elements shown in FIG. 6 may be implemented as software, hardware, or any combination of software and hardware. In a preferred embodiment, the elements in FIG. 6 are implemented as software instructions executed by one or more processors.

As shown in FIG. 6, the applicant screening and processing system includes a controller 610, a network interface 620, an applicant record database interface 630, an optional user interface 640, an applicant screening engine 650, a questionnaire database 660, an incentive/tax credit program business rules engine 670, and a document/report generation engine 680. These elements are in communication with one another via the control/data signal bus 690. Although a bus architecture is shown in FIG. 6, the present invention is not limited to such and any architecture that facilitates the communication of control/data signals between the elements 610-680 may be used without departing from the spirit and scope of the present invention.

The controller 610 controls the overall operation of the applicant screening and processing system and orchestrates the operation of the other elements 620-680. The controller 610 receives log-on requests from client devices via the network interface 620, authenticates the log-on request based on information stored in a authorized user database (not shown) and passes control to an appropriate engine based on the selected options in the log-on request. In addition, the controller 610 initiates retrieval of an applicant's information from the applicant screening record database via the interface 630. If the log-on request indicates that a form is to be re-output or a report is to be generated, the controller 610 passes control to the document/report generation engine 680. Otherwise, if the log-on request indicates that applicant information is to be entered, the controller 610 passes control to the applicant screening engine 650.

The applicant screening engine 650 generates one or more applicant interfaces based on information obtained from the employer profile database 675, the questionnaire database 660, and applicant information retrieved from the applicant screening record database (if any) via the interface 630. The employer profiles database 675 indicates what incentive/tax credit programs are applicable to the particular employer with which the applicant is applying for employment. Based on the designation of incentive/tax credit programs, the applicant screening engine 650 retrieves questions or entire questionnaires from the questionnaire database 660. The fields in these questions or questionnaires may then be partially filled in based on the applicant information retrieved from the applicant screening record database.

The applicant screening engine 650 then presents these generated interfaces to the client device via the network interface 620. These interfaces may take the form of HyperText Markup Language (HTML) documents, applets, editable Adobe Acrobat™ documents, or the like. In short, any mechanism for allowing a user of a client device to enter information and transmit that information to the applicant screening and processing system may be used without departing from the spirit and scope of the present invention.

The controller 610 then receives the completed questionnaires, including the applicant information, from the client device via the network interface 620. The applicant information is extracted from the questionnaire by the applicant screening engine 650 and a control number is generated. The applicant information is stored in the applicant screening record database 630 in association with the applicant (by social security number, for example), the control number, and the employer.

Having stored the applicant information, the controller 610 passes control to the incentive/tax credit program business rules engine 670 which applies business rules, identified based on the employer profile information in the employer profile database 675, to the applicant information extracted by the applicant screening engine 650. The incentive/tax credit program business rules engine 670 then generates one or more results of the application of the business rules to the applicant information identifying whether the applicant is a qualified candidate under one or more incentive/tax credit programs. This result is then forwarded to the controller 610.

The controller 610 then generates an interface based on the results forwarded by the incentive/tax credit program business rules engine 670. The interface may or may not have an option to generate forms depending on the result forwarded. If the interface includes an option to generate forms, and the controller 610 receives a request from the client device to generate these forms, the controller 610 instructs the document/report generation engine 680 to generate the forms using the applicant information and transmit them to the client device for output.

As previously mentioned, if the log-on request includes a selection of the option to generate reports, the controller 610 will pass control to the document/report generation engine 680 which will query the applicant screening record database for applicant screening records meeting the date criteria, or any other search criteria entered. The document/report generation engine 680 will then format the report according to the employer's preferences included in the employer profile database 675 and transmit the report to the employer's computer system via the network interface 620.

Thus, the present invention provides an automated method and apparatus for performing screening of job applicants for incentive/tax credit programs. The present invention reduces the burden on human users by performing much of the applicant information gathering and evaluation in an automated fashion. This greatly reduces the time required for processing of applicant information and reduces the possible sources of human error. Furthermore, the present invention allows for a plurality of incentive/tax credit programs to be managed by a single system. Moreover, customization of questionnaires and reports based on the particular employer profiles is made possible.

FIG. 6 includes an optional user interface 640. This user interface 640 may, in one embodiment, be an interface through which an administrator associated with the applicant screening service provider may perform administrative functions on the applicant screening and processing system. In another embodiment, the user interface 640 may be used by an applicant or a representative of an employer to directly enter log-on requests and applicant information.

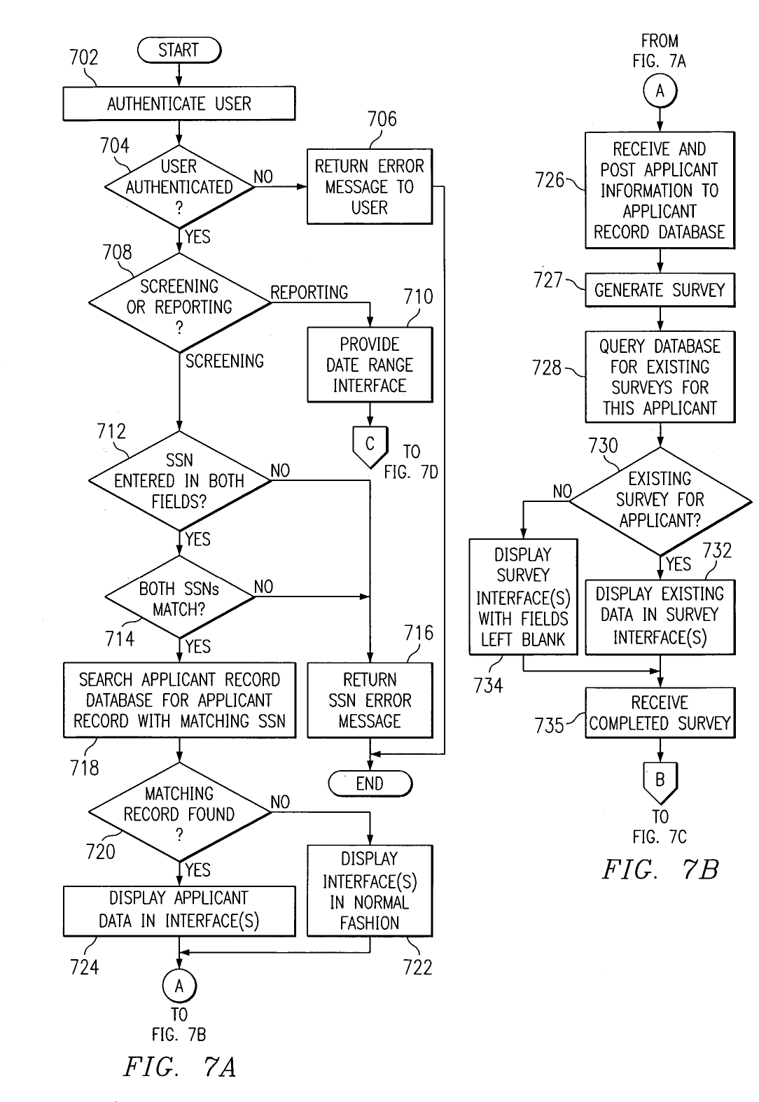

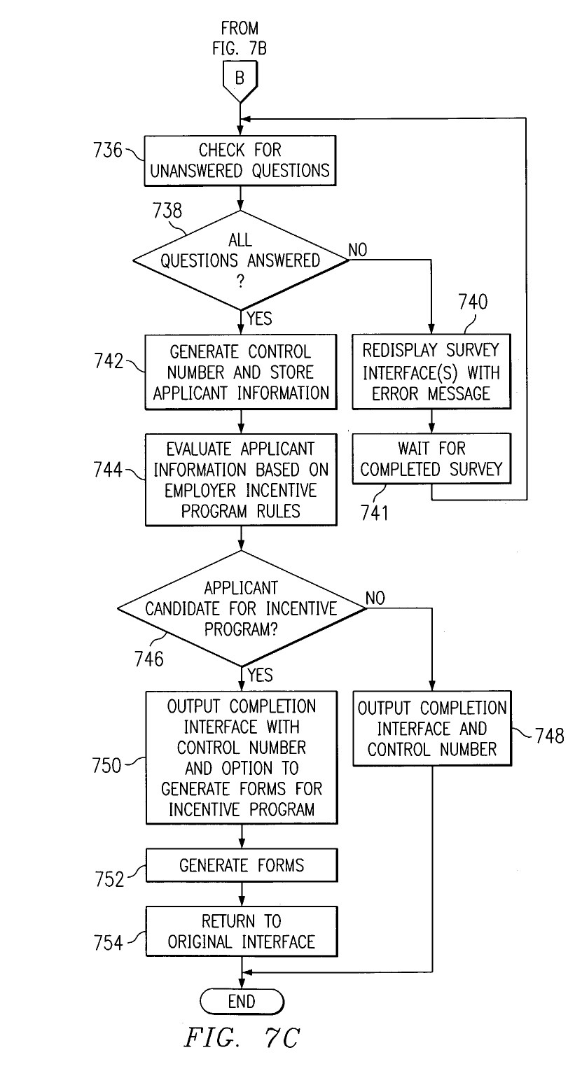

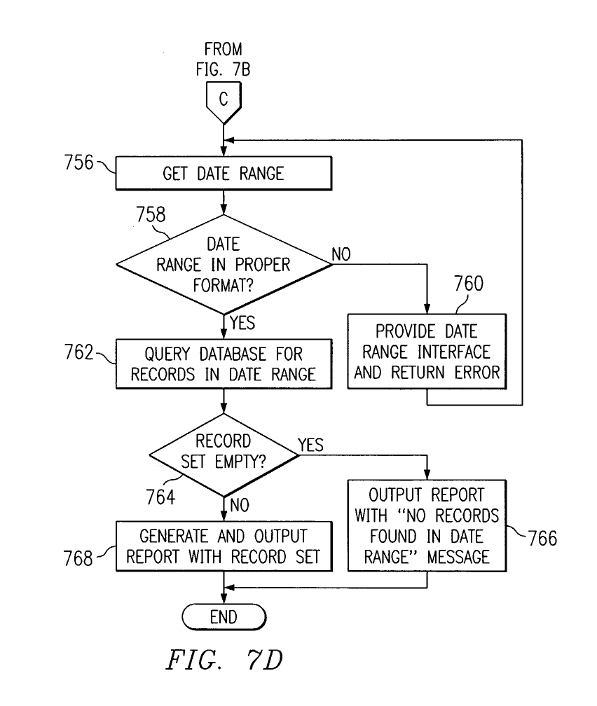

FIG. 7A is a flowchart outlining an exemplary operation of one exemplary embodiment of the present invention with regard to a log-on process. As shown in FIG. 7A, the operation starts with authenticating a user based on a log-on request received from a client device (step 702). A determination is made as to whether the user is authenticated (step 704). If not, an error message is returned to the user (step 706) and the log-on attempt is terminated.

If the user is authenticated, a determination is made as to whether screening options or reporting options were selected during the log-on process (step 708). If reporting options were selected, a date range interface is provided for entry of the date range for the report (step 710) and the operation continues with step 756 in FIG. 7D, discussed hereafter.

If the log-on request includes a selection of a screening option, a determination is made as to whether the social security number (SSN) has been entered in both fields (step 712). In the particular embodiment shown in FIG. 7A, the opening page includes duplicative fields for entry of an applicant's SSN in order to make sure that the SSN was entered correctly. If both fields do not include an SSN, an error message is returned (step 716) and the log-on operation is terminated.

If the SSN has been entered in both fields, a determination is made as to whether both SSNs match (step 714). If not, the operation returns an SSN error message (step 716) and terminates the log-on operation. If both SSNs match, then the applicant screening record database is searched for an applicant record having a matching SSN (step 718).

A determination is made as to whether a matching applicant screening record was found (step 720). If not, the applicant information interfaces are displayed in a normal fashion without applicant information inserted into the fields (step 722). If there is a matching applicant screening record found, the applicant information from this record is inserted into appropriate fields of the applicant information interfaces and displayed to the applicant via the client device (step 724). Whether or not applicant information is inserted into the fields of the applicant information interfaces, the applicant will be allowed to edit any information inserted to thereby update the applicant information.

FIG. 7B is a flowchart outlining an exemplary operation of one exemplary embodiment of the present invention with regard to a process for screening an applicant. As shown in FIG. 7B, the operation starts by receiving and posting applicant information to an applicant screening record database (step 726). The survey to be provided to the applicant is then generated (step 727). As discussed above, this may involve determining the questions to be included in the survey based on the employer profile, for example.

The applicant screening record database is queried for existing surveys for this applicant (step 728). A determination is made as to whether there are existing surveys for this applicant (step 730). If so, the existing data is inserted into the survey interface(s) and presented via the client device (step 732). Otherwise, the survey interface(s) are presented with fields left blank (step 734). The applicant's completed survey is then received (step 735).

FIG. 7C is a flowchart outlining an exemplary operation of the present invention with regard to a process for evaluating applicant information obtained through screening. As shown in FIG. 7C, the operation starts with checking the completed survey for unanswered questions (step 736). A determination is made as to whether all the questions have been answered (step 738). If not, the survey interface(s) are redisplayed with an error message (step 740). The operation then waits to receive the corrected applicant information from a completed survey (step 741) and returns to step 736.

If all questions have been answered, a control number is generated and the applicant information is stored in the applicant screening record database (step 742). The applicant information is then evaluated based on incentive/tax credit program business rules (step 744). As previously mentioned, this may involve applying one or more sets of business rules identified by the employer profile.

A determination is then made as to whether the applicant is a candidate for one or more incentive/tax credit programs (step 746). If not, the “thank you” or completion interface is output with the control number (step 748). If the applicant is a candidate for an incentive/tax credit program, a completion interface is output with the control number and an option to generate forms for the particular incentive/tax credit program(s) (step 750). The forms are then generated and transmitted to the client device (step 752), the operation returns to the opening page (step 754) and the operation ends.

FIG. 7D is a flowchart outlining an exemplary operation of the present invention with regard to a process for generating a report. As shown in FIG. 7D, the operation starts with obtaining a date range (step 756). A determination is made as to whether the date range is in a proper format (step 758). If not, a date range interface is provided and an error returned (step 760). If the date range is in a proper format, the applicant screening record database is queried for records in the designated date range (step 762).

A determination is made as to whether the record set is empty (step 764). If so, an output report is generated with a “No Records Found in Date Range” message (step 766). If the record set is not empty, output reports are generated and populated with the record set (step 767). As previously mentioned, the generation of the reports may be based on preferences identified in the employer profiles database.

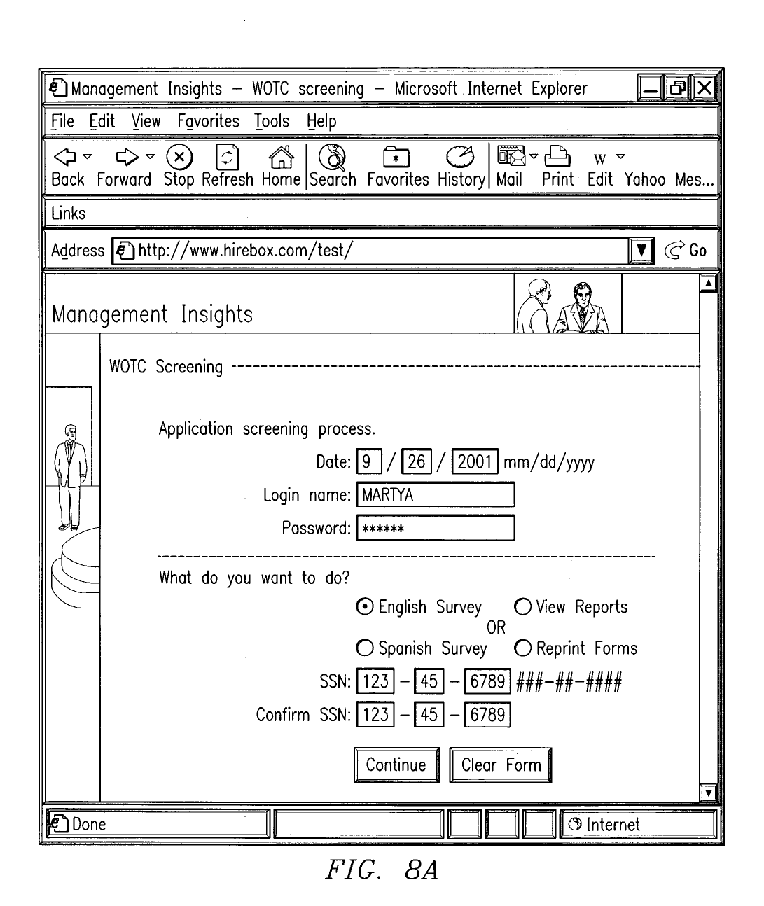

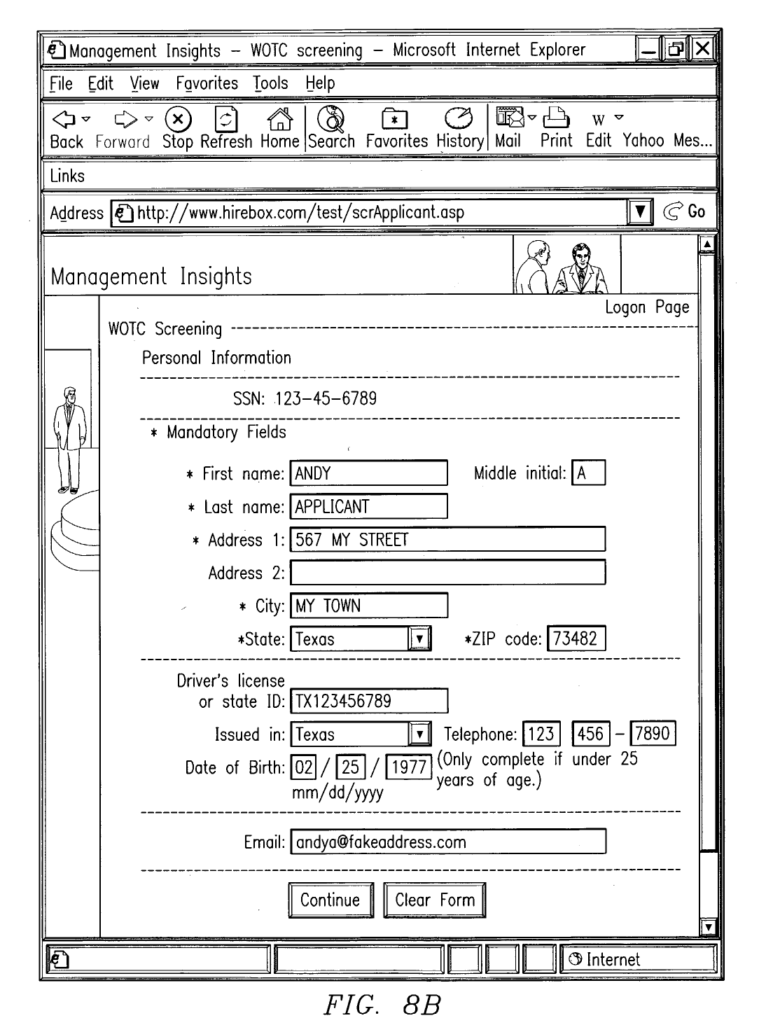

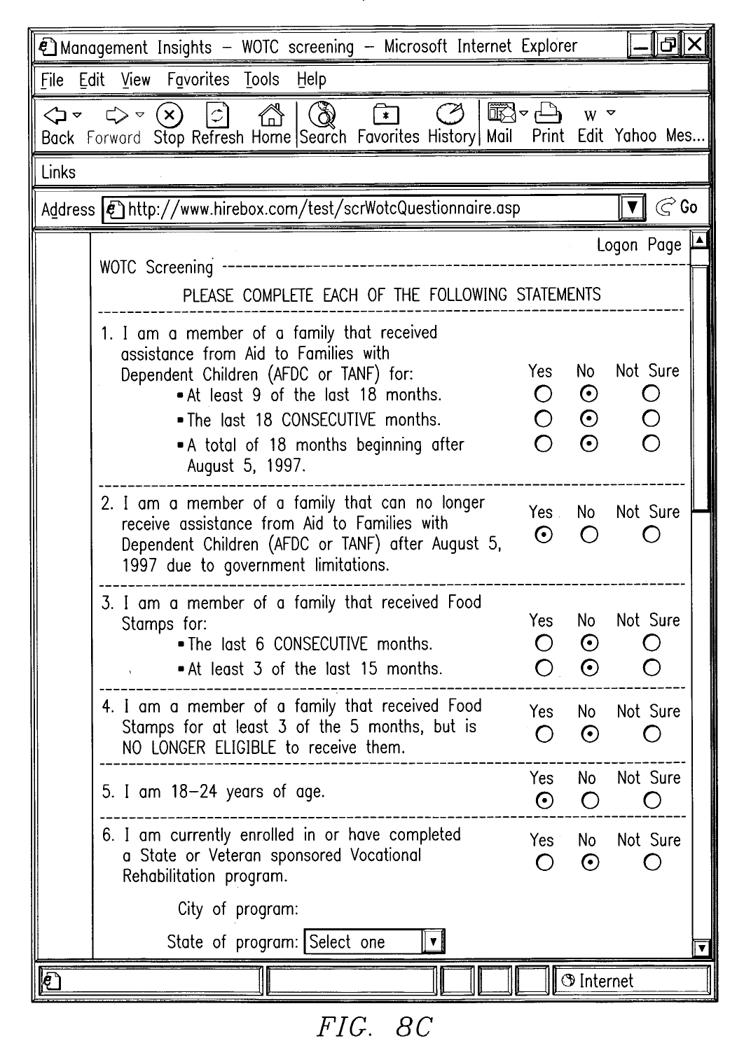

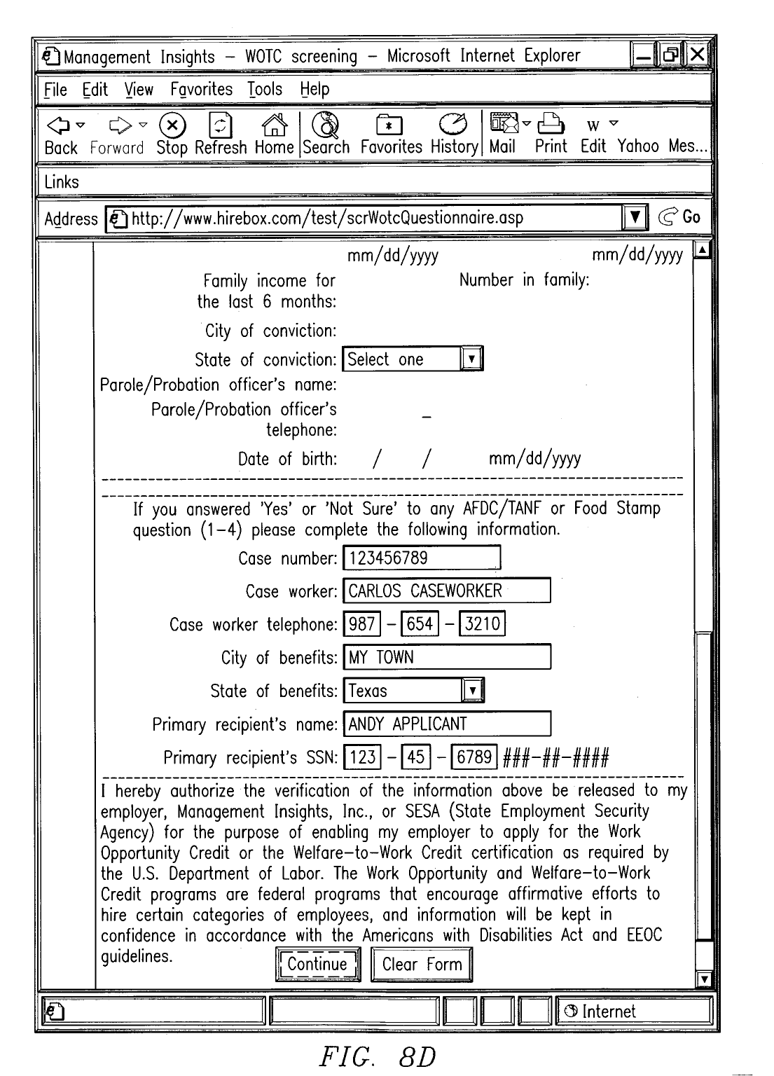

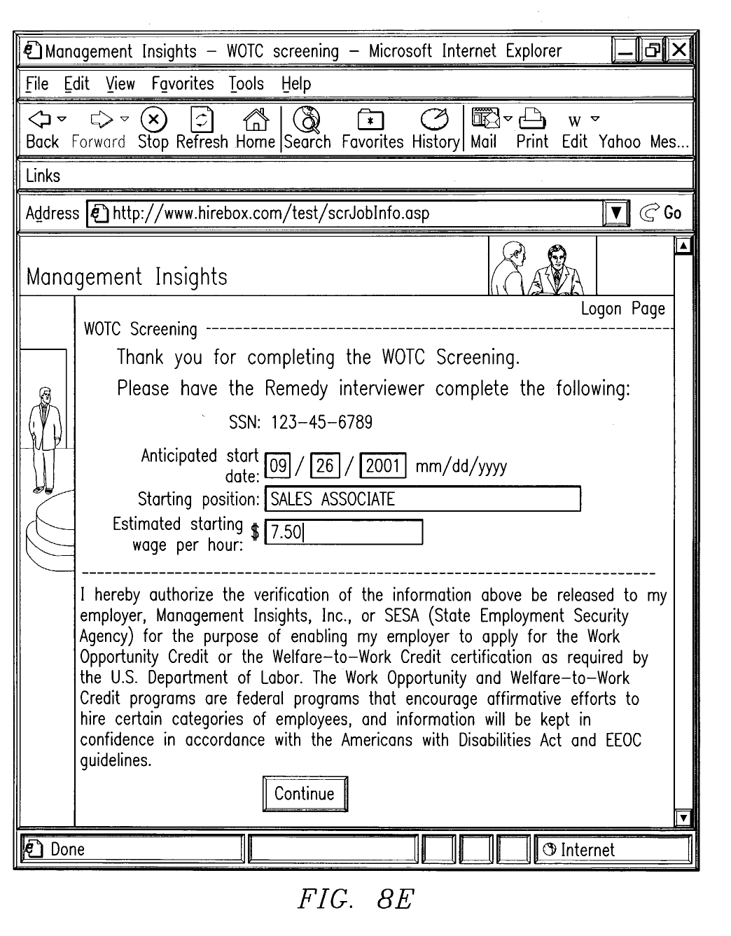

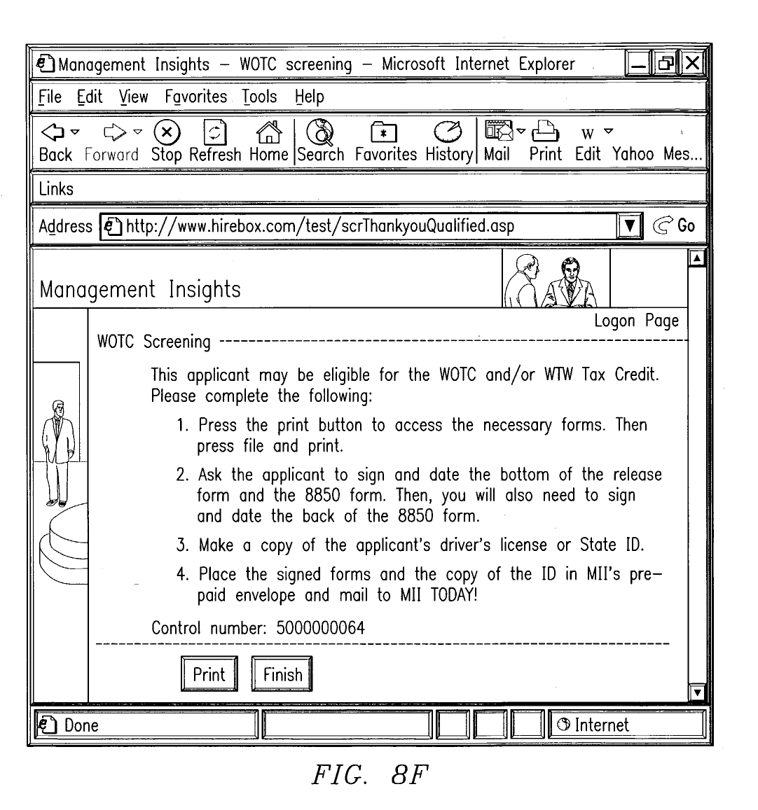

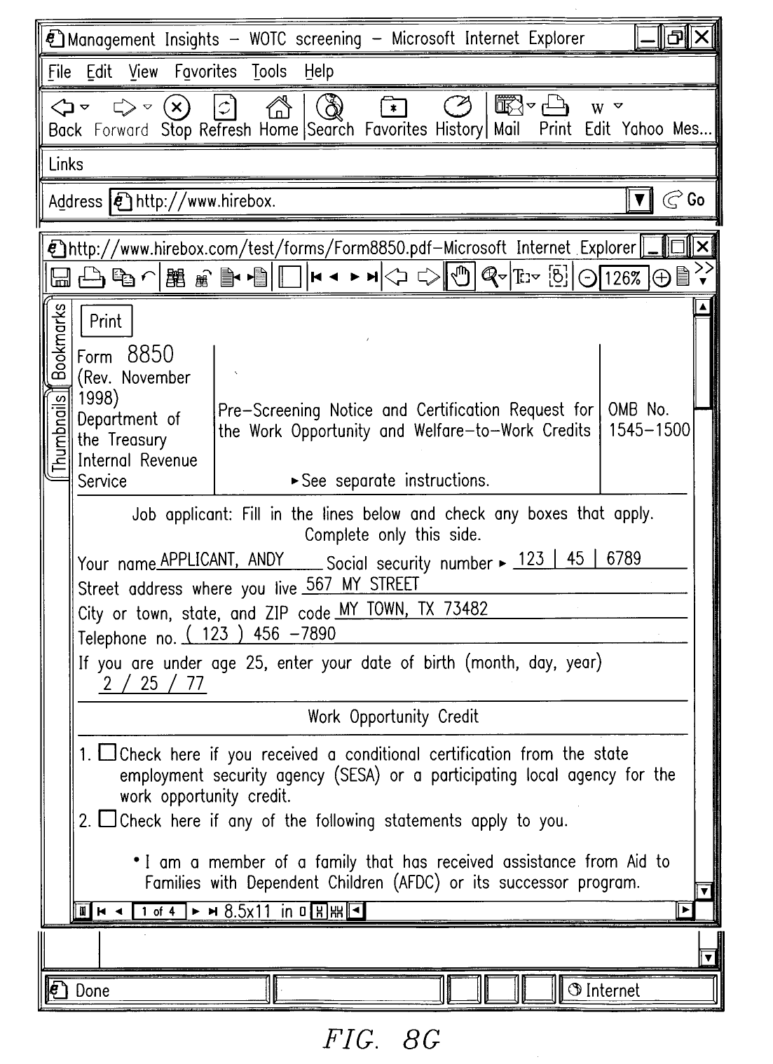

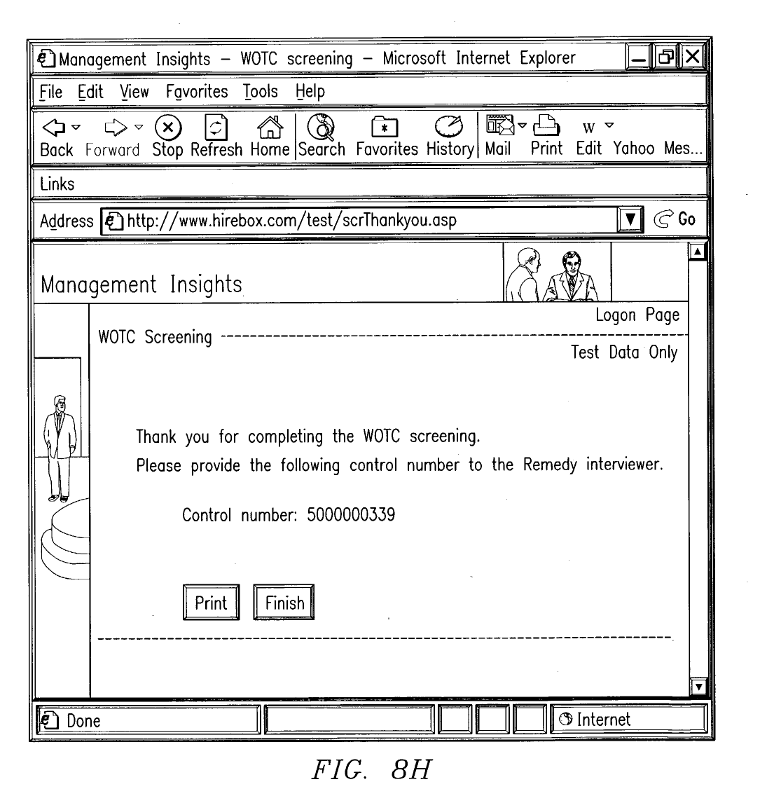

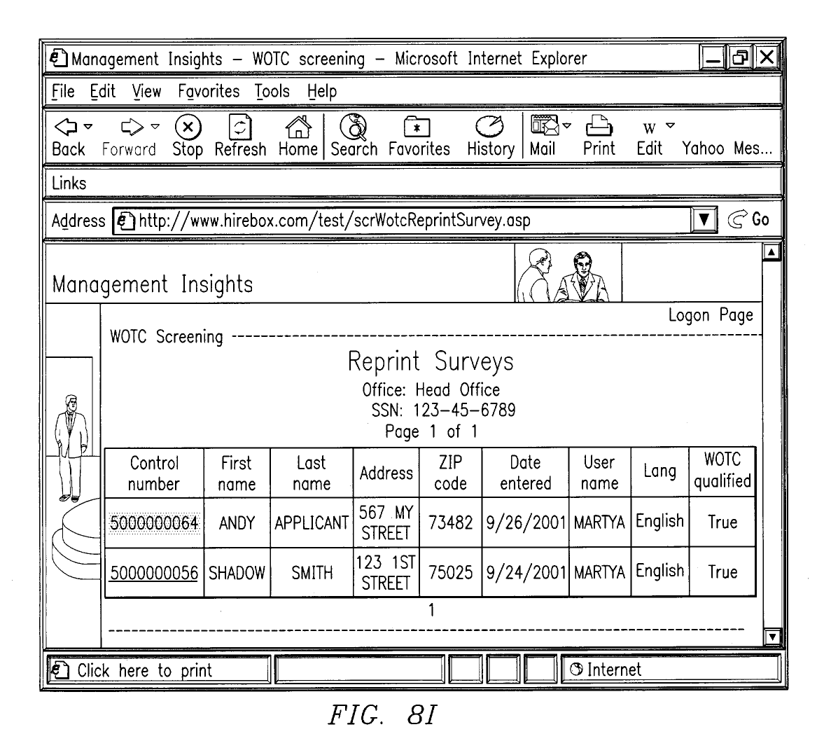

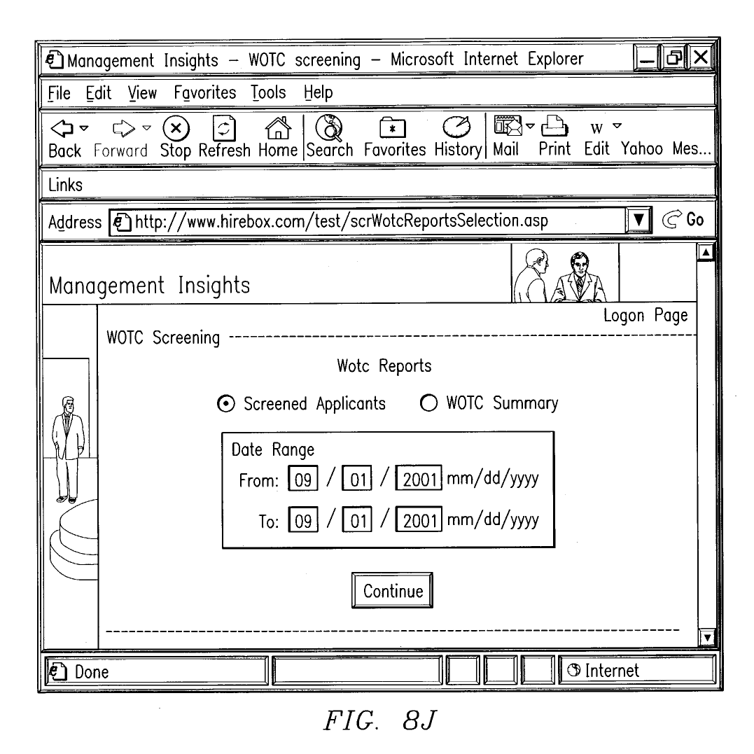

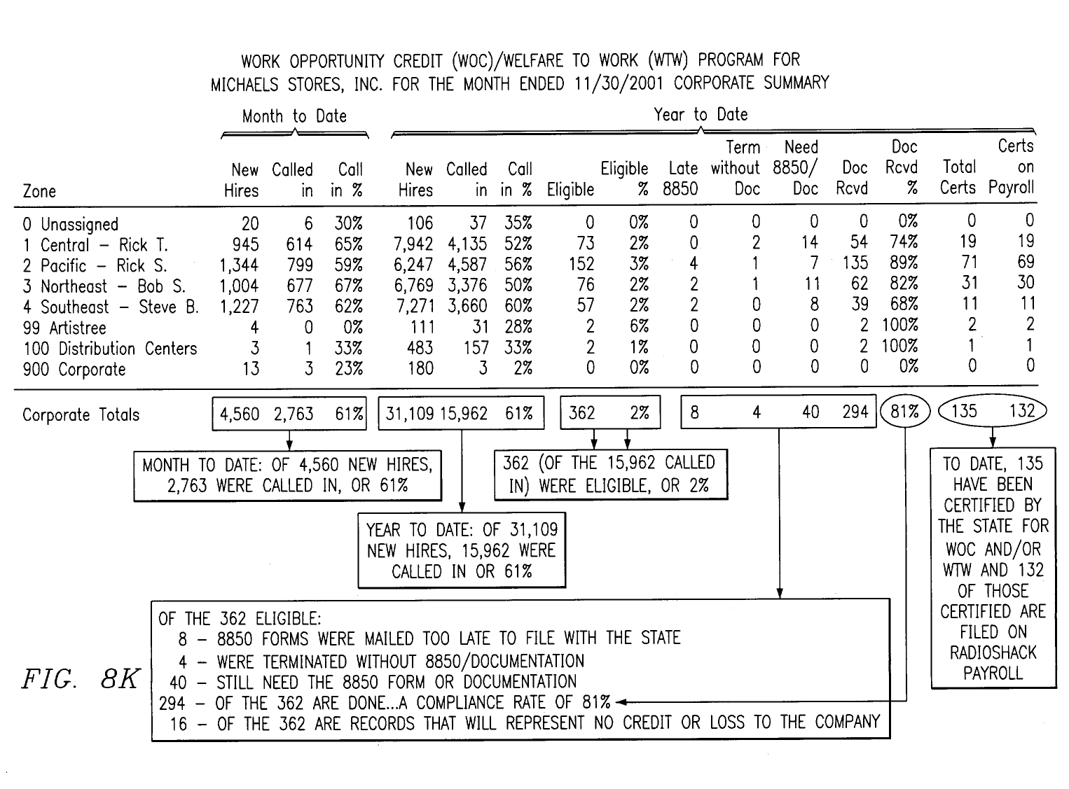

As described above, the present invention provides a number of interfaces to client devices in order to gather information from applicants, representatives of employers, and to output results of applicant screening and processing. FIGS. 8A-8I provide example screenshots of one exemplary embodiment of the present invention illustrating these various interfaces. The interfaces shown in FIGS. 8A-8I are HTML documents displayed through a Microsoft Windows™ environment running a web browser such as Microsoft Internet Explorer™. It should be noted, however, that these figures are for illustrative purposes only and no limitation on the particular implementations of the present invention are intended or should be inferred from the interfaces depicted in FIGS. 8A-8I.

FIG. 8A is an exemplary diagram of an interface for logging-on to an applicant screening and processing system according to one embodiment of the present invention. As shown in FIG. 8A, this interface includes fields for entry of the date, login name and password of the user. The user that enters this information will typically be a representative of the employer, also referred to as a Remedy Interviewer, although the present invention does not limit who can be a user. This interface further includes fields for designating whether to provide applicant information through a survey, what language the survey is to be in, to view reports, or reprint forms. In addition, fields are provided for entry and confirmation of an applicant's social security number. Virtual buttons are provided to clear the interface or to continue to the next interface.

FIG. 8B is an exemplary diagram of an interface for providing personal information about an applicant according to one embodiment of the present invention. As shown in FIG. 8B, the interface contains fields for entry of a plurality of different personal information about the applicant including name, address, driver's license information, date of birth, electronic mail address, etc. This information will typically be entered by the applicant himself/herself. The information gathered through this interface may be stored in the applicant screening records database regardless of whether or not the applicant continues on to the next interface or not.

FIGS. 8C and 8D are exemplary diagrams of a survey interface for performing WOTC/WtW screening according to one embodiment of the present invention. As shown in these Figures, questionnaire questions are presented along with “boxes” which may be checked by the applicant to indicate his/her response to the question. Additional fields are provided for entry of additional information about an applicant's response to a question, as shown in FIG. 8D.

FIG. 8E is an exemplary diagram of an interface for providing employment detail information according to one embodiment of the present invention. This interface may be provided upon processing of the applicant information gathered through the interfaces shown in FIGS. 8A-8D if the applicant is determined to be a candidate for the WOTC/WtW programs. The interface includes fields for entry of the anticipated start date of the applicant, the starting position of the applicant, and estimated salary for the applicant.

FIG. 8F is an exemplary diagram of an interface for informing an employer that the applicant may be a candidate under an incentive/tax credit program according to one embodiment of the present invention. This interface provides virtual buttons for selecting the generation and printing of forms for filing under the WOTC/WtW programs or for finishing without printing the necessary forms.

FIG. 8G is an exemplary diagram of an interface for generating one or more documents for applying for the incentive/tax credit according to one embodiment of the present invention. As shown in FIG. 8G, upon selection of the print virtual button in FIG. 8F, a completely filled in IRS Form 8850 (required for filing under the WOTC/WtW programs) is generated and may be printed. In the particular embodiment shown in FIG. 8G, the document is generated as a PDF formatted document that is opened using Adobe Acrobat™ Reader. The user may then use the print function of Adobe Acrobat™ Reader to print the form and have the applicant sign it.

FIG. 8H is an exemplary diagram of an interface for informing an employer of a control number for an applicant that does not meet criteria for an incentive/tax credit program according to one embodiment of the present invention. As can be seen from FIG. 8H, the screen does not include an option for printing the forms for filing under the WOTC/WtW programs. Rather, the print button provided is used to print a copy of the screen in order to have a hard copy of the control number.

FIG. 8I is an exemplary diagram of an interface for performing a reprint of surveys according to one embodiment of the present invention. As shown in FIG. 8I, the interface provides a listing of surveys completed by an applicant designated by the social security number entered in the interface of FIG. 8A. From this interface, a user may select a survey and have it reprinted.

FIG. 8J is an exemplary diagram of an interface for obtaining an employer report according to one embodiment of the present invention. As shown in FIG. 8J, this interface provides fields for designating the type of report to be output as well as the date range for the report. A “continue” virtual button is provided as a means for submitting the request to the applicant screening and processing system to thereby generate the report.

FIG. 8K is an exemplary diagram of an employer report according to one embodiment of the present invention. The report shown in FIG. 8K illustrates a report that may be generated through the interface of FIG. 8J. The report provides a number of different fields containing information that may be of interest to employers regarding the applicants processed within the designated date range. This information may include, for example, the number of new hires, the number processed (called in), the percentage of new hires processed (called in), how many and what percentage were eligible under an incentive/tax credit program, the number that submitted a late form, etc.

Thus, the present invention provides a mechanism for screening applicants with regard to incentive/tax credit programs. The above embodiments eliminate much of the human intervention necessary to identify applicants qualified under one or more incentive/tax credit programs. However, the above embodiments still include some human intervention that may be eliminated through proper extension of the automation of the present invention.

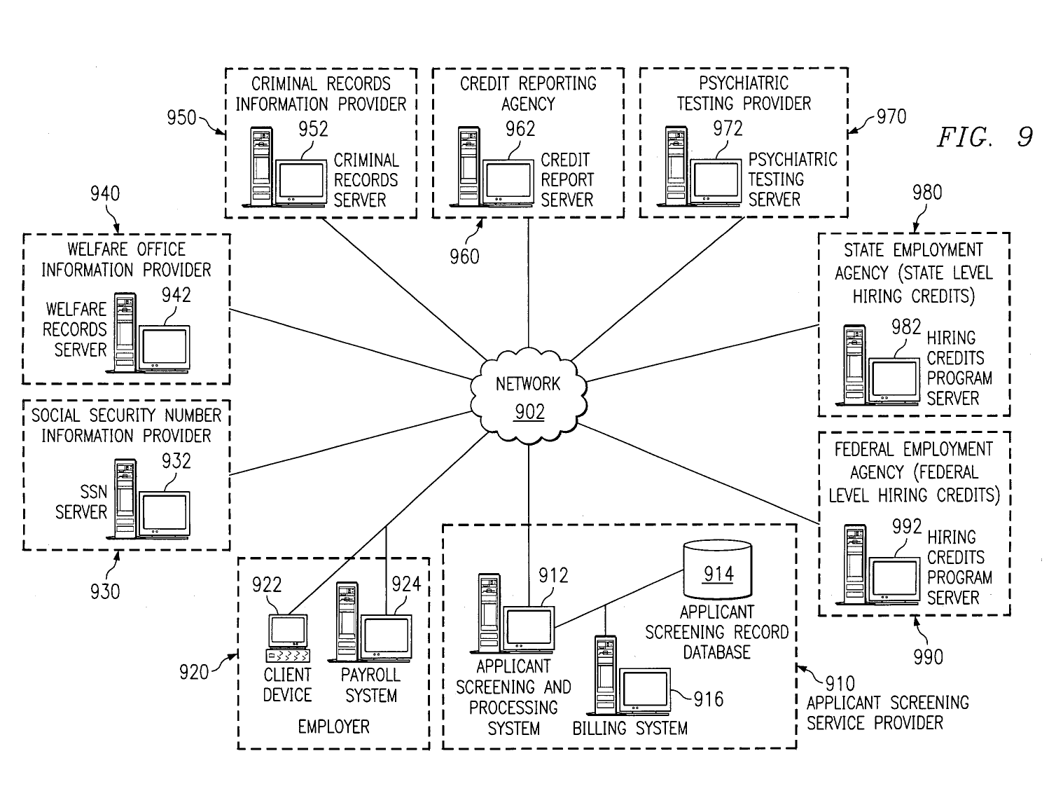

FIG. 9 is an exemplary block diagram of a distributed data processing system according to another exemplary embodiment of the present invention in which additional automation to perform verification of applicant information and to perform automatic filing of forms with appropriate regulatory agencies is provided. As shown in FIG. 9, in addition to the employer 920 and the applicant screening service provider 910, additional third party entities 930-990 are provided with which the applicant screening and processing system interfaces in order to automatically validate applicant information, file forms with the regulating agencies, verify employment, and the like.

The applicant screening and processing system 912 operates in much the same manner as previously discussed above. However, in addition to the interaction between the applicant screening and processing system 912 and the client device 922, the applicant screening and processing system 912 performs validation of the applicant information submitted by the applicant through interaction with a social security number information provider 930, a welfare office information provider 940, and a criminal records information provider 950. While FIG. 9 shows one exemplary entity of each type, it should be appreciated that there may be a plurality of entities of each type with which the applicant screening and processing system 912 interfaces. For example, the applicant screening and processing system 912 may interface with criminal records information providers and welfare office information providers in each of the 50 states of the United States of America. Any number of information providers may be utilized with the present invention.

Moreover, the particular examples of information providers shown in FIG. 9 is not intended to be exhaustive of the possible information providers with which the present invention interfaces. Rather, any provider of information that may be useful in validating applicant information may be used without departing from the spirit and scope of the present invention.

With the present invention, when the applicant submits his/her applicant information to the applicant screening and processing system 912, the applicant information is parsed in order to generate requests sent to the information provider servers 932, 942 and 952. These requests are validation requests in which the applicant screening and processing system 912 requests that the social security number information, welfare records information, criminal records information, and the like, submitted in the applicant information interface(s) be confirmed.

Such confirmation may take the form of confirming that the social security number entered matches the name of the applicant entered in a database of valid social security numbers maintained by the social security number information provider 930, for example. Similarly, welfare case number, the name of the applicant, dates, and the like, may be matched with records maintained by the welfare office information provider 940 in order to validate the information submitted by the applicant. The same is true of criminal records information submitted by the applicant.

The applicant screening and processing system 912 receives responses from these information providers and performs appropriate processing based on the response. If the response is that the information submitted is valid, then the operation of the applicant screening and processing system 912 occurs as previously discussed above.

If, however, any of the applicant information is indicated as being invalid, an error condition is generated and the interviewer may be informed of the error condition for further action. In some instances, such as with social security number fraud, the error condition may be logged both in the applicant screening and processing system and in the social security number information provider in order to alert proper authorities as to the fraud. In this way, human authorities associated with the social security number information provider and representatives of the employer and/or applicant screening service provider may work together to reduce the occurrences of social security number fraud.

In addition to the information providers 930-950, the system shown in FIG. 9 includes credit reporting agency 960 and psychiatric testing provider 970 as examples of other third party providers that may be consulted when considering an applicant for employment. The credit reporting agency 960 may provide the applicant screening and processing system 912 with a credit report or a credit rating that may be processed by the applicant screening and processing system 912. If the applicant has questionable credit, a warning may be provided to the interviewer via the client device 922.

In a similar manner as the way in which survey interfaces are provided to the applicant, the screening process may further include psychiatric testing surveys that may be administered to the applicant. These psychiatric testing surveys may then be transmitted to the psychiatric testing provider 970 for analysis. The psychiatric testing provider 970 may then return a result which may be processed by the applicant screening and processing system 912. If the result indicates a potential problem, the interviewer may be informed accordingly.

When the applicant screening and processing system 912 “processes” the credit report result information and psychiatric test result information, what is meant is that a determination is made as to whether the applicant presents a risk to the employer should the employer accept the applicant as an employee. Such processing may include obtaining preferences from an employer profile indicating the levels of acceptable risk for that employer.

In addition to the above, the applicant screening and processing system 912 also interfaces directly with the various incentive/tax credit program servers 982 and 992 of the state and federal agencies 980 and 990 to electronically file the necessary forms for the employer to obtain the incentive/tax credits for hiring a qualified applicant. Rather than printing the forms out, as in the example embodiments described previously, this embodiment of the present invention allows an applicant to submit an electronic signature via the client device 922 which is affixed to the completed electronic forms. The resulting electronic forms are then “filed” in the state and federal agencies by transmitting them to the incentive/tax credit program servers 982 and 992 as new requests for incentives/tax credits. Thus, the human intervention with regard to gathering the applicant's signature and mailing of the forms to the appropriate regulatory agency is eliminated.

Moreover, the applicant screening and processing system 912 may also interface with the employer payroll system 924 which may be part of the employer's systems (as shown) or may be contracted out to a payroll company. By interfacing with the employer payroll system 924, the applicant screening and processing system 912 may verify continued employment of an applicant so that the applicant screening service provider 910 may determine when and to what extent they are owed compensation for screening the applicant. The applicant screening and processing system 912 may then interface with a billing system 916 of the applicant screening service provider 910 to automatically generate a bill, charge an account, or the like, for the agreed upon fees for screening the applicant.

Thus, the present invention provides a mechanism for fully automating the process of accepting applicant information, validating the applicant information, screening the applicant information to determine candidates under one or more incentive/tax credit programs, and filing of the necessary forms for obtaining the incentive/tax credit from the regulating agencies. Moreover, the present invention provides a mechanism by which an employer may obtain additional information regarding the character of the applicant as indicated by information obtained from third party information providers.

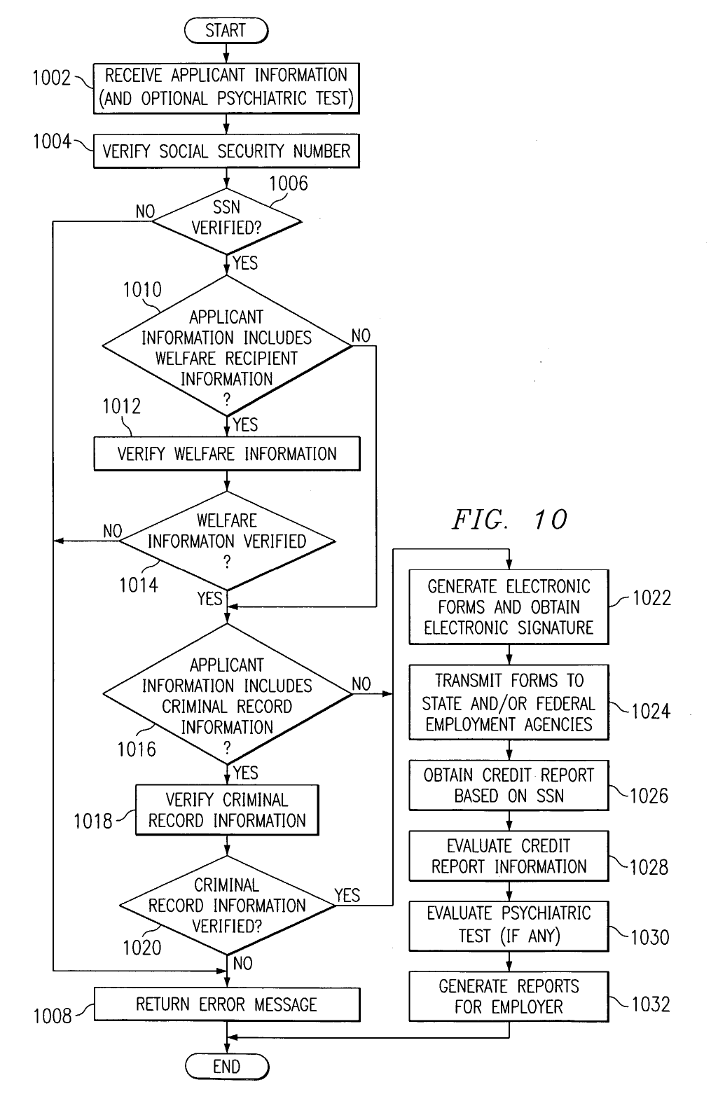

FIG. 10 is a flowchart outlining an exemplary operation of one embodiment of the present invention with regard to automatically performing verification of applicant information and interfacing with employer, government and third party agencies. The operation shown in FIG. 10 assumes that the applicant has previously been identified as a candidate under one or more incentive/tax credit programs. However, many of the functions shown in FIG. 10 may be performed regardless of whether the applicant is a candidate or not.

As shown in FIG. 10, the operation starts with receiving applicant information and optional psychiatric test information (step 1002). The social security number entered by the applicant is then verified with the social security number information provider (step 1004). A determination is made as to whether the social security number is valid (step 1006). If not, an error message is returned (step 1008) and the operation terminates.

If the social security number is valid, a determination is made as to whether the applicant information includes welfare recipient information (step 1010). If so, the welfare information is verified with the welfare information provider (step 1012). A determination is made as to whether the welfare information is valid (step 1014). If not, the operation returns an error (step 1008) and terminates.

If the welfare information is valid or if there is no welfare information included, the operation determines if the applicant information includes criminal record information (step 1016). If so, the criminal record information is verified with the criminal record information provider (step 1018). A determination is made as to whether the criminal record information is valid (step 1020). If not, an error message is returned (step 1008) and the operation terminates.

If the criminal record information is valid or if no criminal record information was included, the operation generates the electronic forms and obtains electronic signatures from the applicant (step 1022). Thereafter, the completed electronic forms with the electronic signatures are transmitted to the regulating agencies (step 1024).

The operation then obtains credit report information from a credit reporting agency based on the applicant's social security number (step 1026) and evaluates this credit report information to determine a risk level (step 1028). The operation also performs an evaluation of any psychiatric test results obtained from the psychiatric test provider to determine a risk level (step 1030). The operation then generates reports for the employer regarding the applicant based on the evaluations performed (step 1032).

It should be noted that while the verification of the criminal record information is performed only in response to the applicant submitting criminal record information, this check may be made regardless of whether the applicant has submitted such information. In other words, this check may be performed in the absence of the applicant submitting criminal record information in order to provide such information to the employer.

It should also be noted that the information gathered from third party information providers, and the fact that applicant information has been validated, may be stored in the applicant screening record database in association with the applicant screening record. In this way, validation may be performed once and need not be repeated.

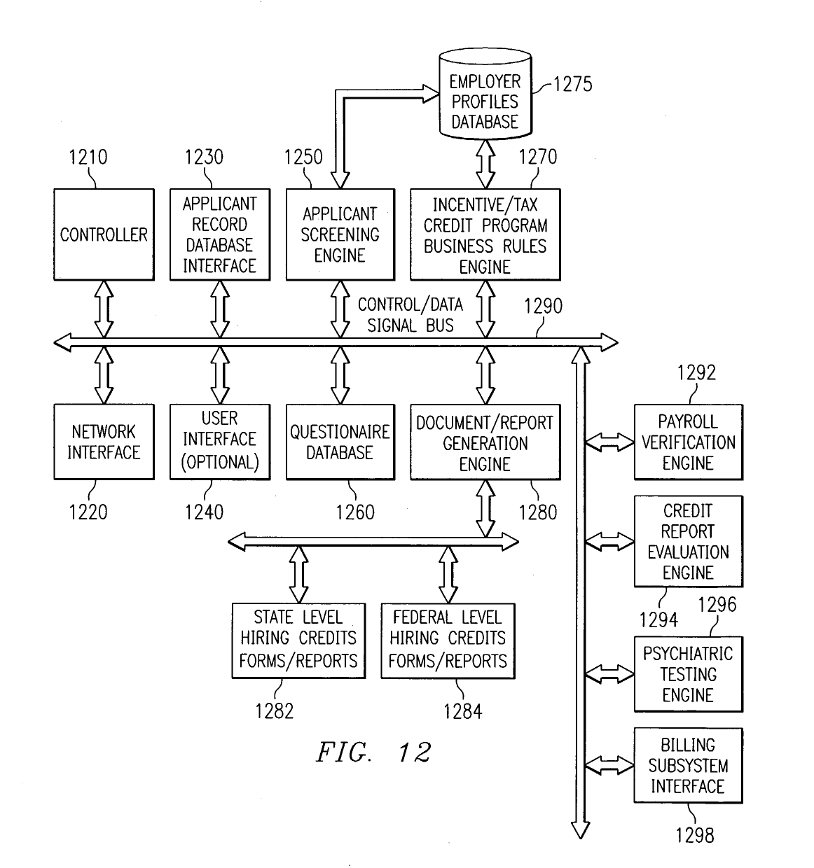

FIG. 11 is a flowchart outlining an exemplary operation of one embodiment of the present invention for interfacing with an employer payroll system to verify employment information and generate billing. As shown in FIG. 11, the operation starts with obtaining applicant information for applicants having start dates more than x number of days ago (step 1102). This step is provided as an example criteria for generating bills to employers. Other criteria may be used without departing from the spirit and scope of the present invention.

For each applicant identified in step 1102, continued employment with the employer is verified (step 1104). As mentioned previously, this step may involve interfacing with the employer's payroll system to determine the employment of the applicant, salary, etc.

A determination is made as to whether the applicant meets the criteria of one or more of the incentive/tax credit programs (step 1106). If not, the operation ends. Otherwise, a bill for services is generated for the applicant by the billing system (step 1108) and is output (step 1110).

FIG. 12 is an exemplary block diagram of an applicant screening and processing system according to another exemplary embodiment. As shown in FIG. 12, elements 1210-1275 and 1290 are similar to and function in a similar way to the corresponding elements in FIG. 6. The controller 1210 performs additional functions of parsing applicant information submitted via the network interface 1220 and transmitting requests for verification to various third party information providers. Based on the responses from these third party information providers, the controller 1210 passes control to additional engines for performing various evaluations.

This embodiment further includes a state level hiring credits form/reports module 1282 and federal level hiring credits form/reports module 1284 associated with the document/report generating engine 1280. These modules are used to generate electronic forms for use in electronic filing of documents with the state and federal regulatory agencies as previously described.

In addition, the embodiment shown in FIG. 12 further includes a payroll verification engine 1292, a credit report evaluation engine 1294, a psychiatric testing engine 1296, and a billing subsystem interface 1298. The payroll verification engine 1292 performs the verification of continued employment of an applicant. Based on the results of the verification, the controller 1210 may interface with the billing subsystem through the billing subsystem interface 1298 and generate a bill for screening the applicant.

The credit report evaluation engine 1294 obtains credit report information forwarded by the controller 1210 and evaluates it based on acceptable risk information included in the employer's profile. The credit report evaluation engine 1294 may apply various rules to generate an indicator of the risk level and compare that risk level to the acceptable risk level for the employer. If the risk is too high, a warning may be output to the interviewer. The psychiatric testing engine 1296 operates in a similar fashion to that of the credit report evaluation engine based on the psychiatric test result information obtained from a third party psychiatric testing provider.

Thus, the present invention provides a fully automated system for accepting applicant information, validating the applicant information, and filing the necessary forms to obtain the incentive/tax credit under the particular programs identified. The present invention eliminates the burden and sources of error present in the known human-based methods of performing similar functions.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computing device, for screening job applicants, comprising:
receiving applicant information;
processing the applicant information to determine if the applicant qualifies under one or more incentive/tax credit programs; and
outputting an indicator of whether or not the applicant qualifies under one or more incentive/tax credit programs.

2. The method of claim 1, wherein receiving applicant information further comprises:
providing at least one interface through which the applicant submits the applicant information.

3. The method of claim 2, wherein the at least one interface includes a questionnaire interface having at least one question directed to determining if the applicant qualifies for one or more incentive/tax credit programs.

4. The method of claim 2, further comprising:
selecting the at least one question based on an employer profile designating the one or more incentive/tax credit programs.

5. The method of claim 1, wherein processing the applicant information to determine if the applicant qualifies under one or more incentive/tax credit programs includes applying one or more sets of business rules associated with the one or more incentive/tax credit programs to the applicant information.

6. The method of claim 1, further comprising:
verifying the applicant information with at least one third party information provider.

7. The method of claim 6, wherein the applicant information includes at least one of social security information, welfare information and criminal record information, and wherein the at least one third party information provider is at least one of a social security information provider, a welfare information provider and a criminal record information provider.

8. The method of claim 1, further comprising:
generating, in response to a determination that the applicant qualifies under one or more incentive/tax credit programs, at least one form for filing with a regulatory agency of the incentive/tax credit program, wherein the at least one form includes the applicant information.

9. The method of claim 8, further comprising:
obtaining an electronic signature on the at least one form; and
transmitting the at least one form with the electronic signature to the regulatory agency via at least one network.

10. The method of claim 1, further comprising:
providing an interface, in response to a determination that the applicant qualifies under one or more incentive/tax credit programs, for entry of employment information regarding conditions of employment.

11. The method of claim 10, further comprising:
verifying the employment information against incentive/tax credit program requirements.

12. The method of claim 1, further comprising:
generating at least one report for an employer based on processing of applicant information for a plurality of applicants for jobs with the employer.

13. A computer program product in a computer readable medium for screening job applicants, comprising:
first instructions for receiving applicant information;
second instructions for processing the applicant information to determine if the applicant qualifies under one or more incentive/tax credit programs; and
third instructions for outputting an indicator of whether or not the applicant qualifies under one or more incentive/tax credit programs.

14. The computer program product of claim 13, wherein the first instructions for receiving applicant information further comprises:
instructions for providing at least one interface through which the applicant submits the applicant information.

15. The computer program product of claim 14, wherein the at least one interface includes a questionnaire interface having at least one question directed to determining if the applicant qualifies for one or more incentive/tax credit programs.

16. The computer program product of claim 14, further comprising:
fourth instructions for selecting the at least one question based on an employer profile designating the one or more incentive/tax credit programs.

17. The computer program product of claim 13, wherein the second instructions for processing the applicant information to determine if the applicant qualifies under one or more incentive/tax credit programs include instructions for applying one or more sets of business rules associated with the one or more incentive/tax credit programs to the applicant information.

18. The computer program product of claim 13, further comprising:
fourth instructions for verifying the applicant information with at least one third party information provider.

19. The computer program product of claim 13, further comprising:
fourth instructions for generating, in response to a determination that the applicant qualifies under one or more incentive/tax credit programs, at least one form for filing with a regulatory agency of the incentive/tax credit program, wherein the at least one form includes the applicant information.

20. An apparatus for screening job applicants, comprising:
means for receiving applicant information;
means for processing the applicant information to determine if the applicant qualifies under one or more incentive/tax credit programs; and
means for outputting an indicator of whether or not the applicant qualifies under one or more incentive/tax credit programs.
